(19) United States
(12) Patent Application Publication
(10) Pub. No.: US 2026/0027771 A1
(43) Pub. Date: Jan. 29, 2026

(54) METHOD AND DEVICE FOR LITHOGRAPHY-BASED ADDITIVE MANUFACTURING OF A THREE-DIMENSIONAL COMPONENT

(71) Applicant: UPNANO GMBH, Wien (AT)

(72) Inventors: Peter GRUBER, Wien (AT); Michael SCHEUCHER, Wien (AT)

(73) Assignee: UPNANO GMBH, Wien (AT)

(21) Appl. No.: 18/997,972

(22) PCT Filed: Jun. 22, 2023
(86) PCT No.: PCT/IB2023/056452

§ 371 Date: Jan. 23, 2025

(30) Foreign Application Priority Data
Aug. 1, 2022 (EP) 22020364.0

(51) Int. Cl. B29C 64/135; B29C 64/245; B29C 64/268; B29C 64/286; B33Y 10/00; B33Y 30/00

(52) U.S. Cl. CPC B29C 64/135; B29C 64/245; B29C 64/268; B29C 64/286; B33Y 10/00; B33Y 30/00

(57) ABSTRACT

Method for lithography-based additive manufacturing of a three-dimensional component. A beam splitter splits a beam into a plurality of beams that are focused on focal points within a material by an optical imaging unit. The focal points are adjusted by means of a deflection unit disposed upstream of the optical imaging unit in the beam direction, whereby a volume element of the material is solidified by means of multiphoton absorption successively at the focal point of each beam, a spatial light modulator having a plurality of electronically controllable pixels is provided, which pixels are scanned by the plurality of beams and are switched individually between at least one on state and one off state as a function of the geometry of the component that is to be realized, with the result that the associated beam is guided to the imaging unit only in the at least one on-state.

### CROSS-REFERENCE TO RELATED APPLICATIONS

The present application is a national phase application of PCT Application No. PCT/IB2023/056452, filed Jun. 22, 2023, entitled “METHOD AND DEVICE FOR LITHOGRAPHY-BASED ADDITIVE MANUFACTURING OF A THREE-DIMENSIONAL COMPONENT”, which claims the benefit of European Patent Application No. 22020364.0, filed Aug. 1, 2022, each of which is incorporated by reference in its entirety.

### BACKGROUND OF THE INVENTION

### 1. Field of the Invention

The invention relates to a method for lithography-based generative manufacturing of a three-dimensional component, in which a beam emitted by an electromagnetic radiation source is split with a beam splitter into a plurality of beams, which are focused on focal points within a material by means of an optical imaging unit and the focal points are displaced in the beam direction by means of a deflection unit arranged upstream of the optical imaging unit, whereby volume elements of the material located at the respective focal points are successively solidified by means of multiphoton absorption.

### 2. Description of the Related Art

The invention furthermore relates to a device for lithography-based generative manufacturing of a three-dimensional component.

A method for the configuration of a component in which the solidification of a photosensitive material is carried out by means of multiphoton absorption is known, for example, from DE 10111422 A1. For this purpose, a focused laser beam is irradiated into the bath of the photosensitive material, whereby the irradiation conditions for a multiphoton absorption process triggering the solidification are only fulfilled in the immediate vicinity of the focus, so that the focus of the beam is guided within the bath volume to the areas to be solidified in accordance with the geometric data of the shaped body to be produced.

A volume element of the material is solidified at the respective focal point, whereby neighboring volume elements adhere to each other and the component is built up by successively solidifying neighboring volume elements. The component can be built up in layers, i.e. the volume elements of a first layer are solidified first before the volume elements of the next layer are solidified.

Irradiation devices for multiphoton absorption processes comprise an optical system for focusing a laser beam and a deflection device for deflecting the laser beam. The deflection device is designed to focus the beam successively on focal points within the material which lie in one and the same plane, preferably perpendicular to the direction of incidence of the beam into the material. In an x,y,z coordinate system, this plane is also referred to as the x,y plane. The solidified volume elements created by the beam deflection in the x,y plane form a layer of the component. To enable the deflection device to work continuously, the beam is interrupted or switched off and on again between the solidification of two successive volume elements.

To build up the next layer, the relative position of the focusing optics relative to the component is changed in the z-direction, which corresponds to the direction of incidence of the at least one beam into the material and runs perpendicular to the x,y-plane. By adjusting the focusing optics relative to the component, which is usually motorized, the focal point is shifted to a new x,y-plane, which is spaced apart from the previous x,y-plane in the z-direction by the desired layer thickness.

Structuring a suitable material using multiphoton absorption offers the advantage of an extremely high structure resolution, whereby volume elements with minimum structure sizes of up to 50 nm×50 nm×50 nm can be achieved. Due to the small focus point volume, however, the throughput of such a process is very low, as more than 109 points have to be exposed for a volume of 1 mm³, for example. This leads to very long construction times, which is the main reason for the low industrial use of multiphoton absorption processes.

In order to increase the component throughput without losing the possibility of a high structural resolution, it has already been proposed to vary the volume of the focal point at least once during the construction of the component, so that the component is constructed from solidified volume elements of different volumes. Due to the variable volume of the focus point, high resolutions are possible (with a small focus point volume). At the same time, a high writing speed (measured in mm³/h) can be achieved (with a large focus point volume). By varying the focus point volume, a high resolution can be combined with high throughput. The variation of the focus point volume can be used, for example, so that a large focus point volume is used inside the component to be built in order to increase the throughput and a smaller focus point volume is used on the surface of the component in order to form the component surface with high resolution. Increasing the focus point volume enables a higher structuring throughput, as the volume of material solidified in an exposure process is increased. In order to maintain high resolution at high throughput, small focal point volumes can be used for finer structures and surfaces, and larger focal point volumes can be used for coarse structures and/or for filling internal spaces. Methods and devices for changing the focus point volume are described in WO 2018/006108 A1.

Another way to increase the writing speed is to use a beam splitter to split the writing beam into a number of writing beams, each of which is focused into the material to be solidified, thus enabling parallel solidification of several volume elements (Kelemen et al: “Parallel photopolymerization with complex light patterns generated by diffractive optical elements”, Optics Express, Vol. 15, No. 22, p. 14488-14497). However, the individual writing beams cannot be positioned independently of each other, so that only a number of similar components corresponding to the number of beams can be produced.

In the field of stereolithography, it is known from U.S. Pat. No. 5,536,467, to control a plurality of writing beams independently of one another, each writing beam being deflected by a separate mirror to the corresponding position in the material to be solidified. A disadvantage, however, is that the deflection device comprises mechanically actuated mirrors, so that the scanning speed is limited, and that the device as shown is not suitable for the solidification of volume elements by means of multiphoton absorption. In addition, the complexity of the equipment increases in proportion to the number of writing beams to be moved independently of each other.

### SUMMARY OF THE INVENTION

The invention aims to further develop a method and a device for the lithography-based generative manufacturing of a three-dimensional component in such a way that the writing speed (measured in mm³/h) is increased even further without restricting the component geometry and with little equipment effort.

To solve this task, a first aspect of the invention provides, in a method of the type mentioned at the beginning, that a spatial light modulator is provided with a plurality of electronically controllable pixels which are raster scanned by the plurality of beams and which are switched individually between at least one on-state and an off-state depending on the geometry of the component to be realized, so that the respective beam is guided to the imaging unit only in the at least one on-state.

The spatial light modulator makes it possible to work with a plurality of beams simultaneously, namely with a plurality of beams which are deflected to move in the same direction by means of the deflection unit, and to control individually for each beam whether or not a volume element is to be solidified by it at a certain position within the material. This enables parallel writing with a plurality of beams without each beam producing the same geometry and without having to provide a separate deflection device for each beam.

In fact, the deflection unit causes a common deflection of all beams, which therefore raster scan (scan) the pixels of the light modulator at a fixed pixel spacing. The number of pixels of the spatial light modulator corresponds to a multiple of the number of beams. As each pixel can now be switched between an on-state and an off-state independently of the state of the other pixels, it is possible to select whether the volume element corresponding to the respective pixel should be solidified within the material or not.

The pixel is the sub-area of the spatial light modulator whose irradiation by a beam in the on-state of the pixel causes the solidification of a volume element in the material.

A significant increase in write speed is also achieved by the fact that, due to the large number of pixels, the sum of the switching rate of all pixels is higher than that of conventional systems, such as e.g. systems that work with an acousto-optical modulator. An acousto-optical modulator is capable of switching a beam on and off at a rate of e.g. 50 MHz so that 50 million volume elements/sec can be written. Currently available spatial light modulators have a lower switching rate per pixel; in the case of a two-dimensional array, the entire pixel array can change its switching state at a rate of e.g. 180 Hz. However, multiplying this by the number of pixels results in an extremely high write speed. Thus, at a corresponding scanning speed of the deflection unit, 360 megapixels/sec can be written with a spatial light modulator having e.g. 2 million pixels and a switching rate of 180 Hz.

According to a preferred configuration of the invention, the pixels of the spatial light modulator are arranged in at least one, e.g. exactly one, row running along a straight line and the splitting of the beams by means of the beam splitter takes place along the straight line so that the beams impinge on the row of pixels spaced apart by a plurality of pixels. The deflection of the beams by the deflection unit also takes place along the aforementioned straight line. For example, the beam splitter generates 50 beams that impinge on the row of pixels along the straight line at a distance of 20 pixels. The deflection unit is now controlled in order to deflect the 50 beams together by an angle so that the beams sweep over the 20 pixels so that at the end of the deflection movement each pixel of the row of 1000 pixels has been irradiated.

In the simplest case, a one-dimensional spatial light modulator is used whose pixels are arranged in a single line. Such a light modulator is also known as a line modulator, whereby the line modulator can be in the form of a “Grating Light Valve”, for example, i.e. as a dynamically adjustable diffraction grating. A separately controllable diffraction grating is provided for each pixel, which comprises, for example, tiny metal strips that can be moved up and down electrostatically. This allows each pixel to be switched back and forth between a grating function and a reflecting mirror.

In the case of a line modulator, beam deflection around only a single axis is required. The beam deflection can be carried out by an acousto-optical deflector, for example, whereby an extremely high deflection speed and thus a high writing speed can be achieved.

Since only volume elements of the component that are located along a straight row can be solidified when using a line modulator, the component or material carrier must be shifted transversely to the row after each row relative to the optical imaging unit in order to write another row.

According to a further preferred embodiment of the invention, the pixels of the spatial light modulator are arranged in several parallel rows. Such a light modulator with a two-dimensional arrangement of the pixels allows the solidification of volume elements within the material in a two-dimensional grid without having to adjust the component or material carrier relative to the optical imaging unit.

The beams are deflected around two axes, preferably perpendicular to each other, whereby a fast scanner can be used for the deflection around a first axis, which corresponds to the axis normal to the beam splitting, and a slower scanner is sufficient for the deflection around a second axis. For example, beam deflection around the first axis is performed using a resonance scanner or a polygon scanner and beam deflection around the second axis is performed using a galvanometer scanner.

A light modulator with a two-dimensional arrangement of pixels can preferably be designed as a reflective liquid crystal microdisplay. Such a light modulator is also referred to as a “Liquid Crystal on Silicone device” or “LCOS device”.

Moreover, the use of a spatial light modulator according to the invention allows a simple pixel-by-pixel adjustment of the radiation intensity of the beam focused into the material in order to achieve a so-called “grayscaling”. In this context, a preferred embodiment of the method according to the invention provides that the at least one on-state comprises at least a first and a second on-state, wherein the pixels are individually switched between the off-state and the first and the second on-state, wherein the first and the second on-state generate different radiation intensities at the focal point. This grayscale function offers the advantage that the intensity of the radiation introduced can be controlled per pixel.

This can be used to achieve homogenization of the radiation power across all volume elements, i.e. to ensure that each volume element of the material is irradiated with the same radiation power. Adjusting or reducing the radiation intensity is advantageous, for example, for those volume elements that are located at the reversal points of the beam deflection and could therefore be irradiated for longer than volume elements located in between. The same applies to volume elements or pixels that are covered twice during raster scanning. In this context, a preferred configuration of the invention provides for the radiation intensity of each pixel of the spatial light modulator to be adjustable and for the radiation intensity to be set depending on the exposure time of the pixels in such a way that the volume elements receive the same radiation power. A suitable control unit is provided for this purpose, which adjusts the radiation intensity depending on the exposure duration.

Alternatively or additionally, the adjustment of the radiation intensity can also be used to vary the radiation power at individual volume elements in order to achieve a height profile in the z-direction without changing the relative position between the imaging unit and the building platform. In this context, a preferred configuration of the invention provides that the radiation intensity of each pixel of the spatial light modulator is adjustable and the radiation intensity is set in such a way that volume elements receive different radiation powers from one another in order to generate volume elements with different spatial dimensions from one another, in particular in the irradiation direction. The radiation power is preferably set by means of a suitable control unit.

Spatial light modulators are usually designed in such a way that the incident light beam is reflected in the at least one on-state of the respective pixel. In order to enable the simplest possible structure, which allows the spatial light modulator to be arranged between the deflection unit and the beam splitter on the one hand and the optical imaging unit on the other, a preferred embodiment of the invention provides that the plurality of beams are directed onto the spatial light modulator with the interposition of a polarizing beam splitter, the beams are reflected by the spatial light modulator through the pixels located in the on-state and impinge with changed polarization onto the polarizing beam splitter, which directs the beams to the optical imaging unit.

In a preferred further refinement of the above setup, a mirror can be provided, whereby the spatial light modulator and the mirror are displaced in such a way that either the spatial light modulator or the mirror is optionally brought into a working position arranged in the beam path. This makes it possible to switch between writing a component using the light modulator according to the invention and conventional parallel writing of alike components.

In another further refinement, the beam splitter can be designed as a spatial light modulator that generates a static hologram or a dynamic light modulation.

Preferably, the component is built up in layers with layers extending in an x-y plane, whereby the change from one layer to the next layer involves changing the relative position of the optical imaging unit relative to the component in a z direction running perpendicular to the x-y plane. The z-direction essentially corresponds to the direction of incidence of the multiple writing beams.

A preferred method results when the material is present on a material carrier, such as in a vat, and the irradiation of the material is carried out from below through the material carrier, which is at least partially transparent to the radiation. A build platform can be positioned at a distance from the material carrier and the component can be built up on the build platform by solidifying the material between the build platform and the material carrier. Alternatively, it is also possible to irradiate the material from above.

The principle of multiphoton absorption is used in the context of the invention to initiate a photochemical process in the photosensitive material bath.

Multiphoton absorption methods also include, for example, 2-photon absorption methods. As a result of the photochemical reaction, the material changes into at least one other state, typically resulting in photopolymerization. The principle of multiphoton absorption is based on the fact that the mentioned photochemical process only takes place in those areas of the beam path in which there is sufficient photon density for multiphoton absorption. The highest photon density occurs at the focal point of the optical imaging system, so that multiphoton absorption is sufficiently likely to occur only at the focal point. Outside the focal point, the photon density is lower, so that the probability of multiphoton absorption outside the focal point is too low to cause an irreversible change in the material through a photochemical reaction. The electromagnetic radiation can pass through the material largely unhindered at the wavelength used and interaction between the photosensitive material and electromagnetic radiation only occurs at the focal point. The principle of multiphoton absorption is described, for example, in Zipfel et al, “Nonlinear magic: multiphoton microscopy in the biosciences”, NATURE BIOTECHNOLOGY VOLUME 21 NUMBER 11 Nov. 2003.

The source for the electromagnetic radiation can preferably be a collimated laser beam. The laser can emit one or more fixed or variable wavelengths. In particular, it is a continuous or pulsed laser with pulse lengths in the nanosecond, picosecond or femtosecond range. A pulsed femtosecond laser offers the advantage that a lower average power is required for multiphoton absorption.

Photosensitive material is any material that is flowable or solid under construction conditions and that changes to a second state through multiphoton absorption in the focus point volume—for example through polymerization. The material change must be limited to the focus point volume and its immediate surroundings. The change in the substance properties can be permanent and consist, for example, of a change from a liquid to a solid state, but can also be only temporary. Besides, also a permanent change can be reversible or non-reversible. The change in material properties does not necessarily have to be a complete transition from one state to the other, but can also be a mixture of both states.

According to a second aspect of the invention, there is provided a device for lithography-based generative manufacturing of a three-dimensional component, in particular for carrying out a method according to the first aspect of the invention, comprising a material carrier for a solidifiable material and an irradiation device which can be controlled for position-selective irradiation of the solidifiable material with at least one beam, wherein the irradiation device comprises a beam splitter for splitting an input beam into a plurality of beams, a deflection unit arranged upstream or downstream of the beam splitter in the beam path and an optical imaging unit arranged downstream of the deflection unit and the beam splitter in order to focus each beam successively onto focal points within the material, whereby a respective volume element of the material located at the focal point can be solidified by means of multiphoton absorption. The device is characterized in that a spatial light modulator with a plurality of electronically controllable pixels, which can be scanned by the plurality of beams and which can be switched individually between at least one on-state and an off-state, is arranged between the imaging unit on the one hand and the beam splitter and the deflection unit on the other hand, so that the respective beam is guided to the imaging unit only in the at least one on-state.

A diffractive optical element can be used as a beam splitter, such as the 1D diffractive beam splitter MS-802-I-Y-A or MS-304-Y-I-Y from HOLO/OR Ltd.

For example, an acousto-optical modulator, a resonance scanner, a polygon scanner, a galvanometer scanner or combinations thereof can be used as a deflection unit.

The beam splitter can be arranged either before or after the deflection unit. In view of the limited angle tolerance of beam splitters, arranging the beam splitter after the deflection unit is only an option if the maximum deflection angle is relatively small. For larger deflection angles, it is preferable for the deflection unit to be arranged after the beam splitter.

According to a preferred configuration, the spatial light modulator comprises a one-dimensional arrangement of the pixels. In particular, the spatial light modulator may comprise a dynamically adjustable diffraction grating. As already explained in connection with the first aspect of the invention, a so-called line modulator can be used here. A line modulator is able to change the state of the individual pixels with a frequency of at least 300 MHz, so that extremely high scanning and thus writing speeds can be achieved.

The deflection unit can preferably comprise at least one acousto-optical modulator, whereby the acousto-optical modulator can be arranged in front of the deflection unit. An acousto-optical modulator is an optical component that influences the frequency, propagation direction and/or intensity of incident light. For this purpose, an optical grating is generated in a transparent solid body with sound waves, at which the light beam is diffracted. In configurations known as acousto-optical deflectors, this can be used to generate a beam deflection, whereby the deflection angle depends on the relative wavelengths of light and sound waves in the transparent solid. The deflection angle can be adjusted by changing the sound wave frequency.

According to a further preferred configuration, it is provided that the spatial light modulator comprises a two-dimensional arrangement of the pixels. In this context, the spatial light modulator may, for example, be designed as a reflective liquid crystal microdisplay. Such LCOS devices have frame rates of >60 Hz, which means that the entire pixel grid can be changed over 60 times per second with regard to the pixel states. In the case of a layered structure of the component, at least 60 layers of volume elements per second can thus be generated in the material, if the time required to change the layer is not taken into account.

For scanning the two-dimensional pixel grid by the plurality of beams, it is preferably provided that the deflection unit is configured as a two-axis deflection unit and preferably comprises a resonance scanner or a polygon scanner for beam deflection about a first axis and a galvanometer scanner for beam deflection about a second axis.

In another preferred embodiment, a polarizing beam splitter is allocated to the spatial light modulator, through which the plurality of beams are directed to the spatial light modulator and which redirects the beams reflected by the spatial light modulator to the optical imaging unit.

The polarization of the beams is preferably achieved by arranging a waveplate, in particular a 2/2 or 24 plate, between the polarizing beam splitter and the spatial light modulator. This rotates the polarization of the beams, resulting in an overall change of 90° at the polarizing beam splitter.

A preferred extension of the described arrangement of the light modulator is that a mirror is provided and that the spatial light modulator and the mirror can be displaced in such a way that either the spatial light modulator or the mirror can be brought into a working position arranged in the beam path.

Preferably, the irradiation device is designed to build up the component layer by layer with layers extending in an x-y plane, the change from one layer to a next layer comprising the change of the relative position of the optical imaging unit relative to the component in a z-direction perpendicular to the x-y plane.

Furthermore, it may be provided that the material is present on a material carrier, such as in a vat, and the irradiation of the material takes place from below through the material carrier, which is at least partially transparent to the radiation.

The build platform is preferably positioned at a distance from the material carrier and the component is built up on the build platform by solidifying volume elements located between the build platform and the material carrier.

The imaging unit can be designed as an f-theta lens or preferably consists of a microscopy lens and relay optics in a 4f-configuration, with the deflection unit and the objective lens sitting in the focal plane of the corresponding lenses.

### BRIEF DESCRIPTION OF THE DRAWINGS

The invention is explained in more detail below with reference to schematic embodiments shown in the drawing. Therein,

FIG. 1 shows a schematic representation of a first embodiment of the device according to the invention,

FIG. 2 shows a schematic representation of a second embodiment of the device according to the invention,

FIG. 3 shows a modified configuration of the first and second embodiments,

FIG. 4 shows a schematic representation of the scanning of the pixels of a spatial light modulator,

FIG. 5 shows a representation according to FIG. 4 in a modified configuration and

FIG. 6 shows a representation according to FIG. 4 in a further modified configuration.

### DETAILED DESCRIPTION

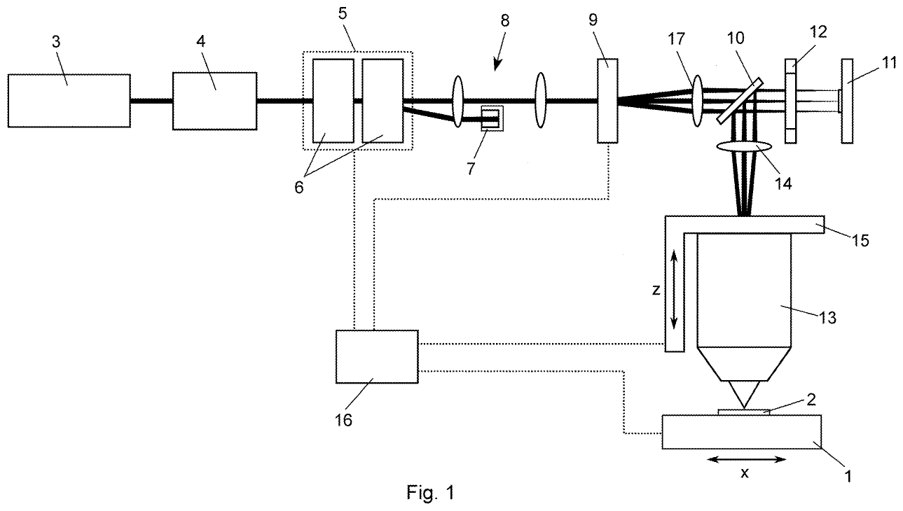

In FIG. 1, a carrier is labelled 1 on which a component is to be built. The carrier 1 is coated with a photopolymerizable material 2 into which laser beams are focused, whereby each laser beam is successively focused on focal points within the photopolymerizable material, whereby a volume element of the material located at the focal point is solidified by means of multiphoton absorption. For this purpose, a laser beam is emitted from a radiation source 3, passed through a pulse compressor 4 and deflected uniaxially by an acousto-optical modulator module 5 comprising two acousto-optical modulators 6 to perform a back and forth movement. The beam of zeroth order is collected in a beam trap 7. The beam of first order is guided via a relay system 8 to a beam splitter 9, which splits the beam into a plurality of beams that are guided via a scan lens 17 to a polarizing beam splitter 10. The polarizing beam splitter is designed to transmit the plurality of beams in the direction of a spatial light modulator 11. The beams pass through a waveplate 12, which delays a polarization component relatively, e.g. by 24. The polarization of the beams reflected by the spatial light modulator 11 is rotated again in the waveplate 12 so that they are deflected in the direction of the optical imaging unit 13 when they hit the polarizing beam splitter 10. The beams reach the optical imaging unit 13 via a tubular lens 14. The optical imaging unit 13 comprises an objective which focuses the laser beams within a writing area into the material 2.

In the configuration according to FIG. 1, the spatial light modulator 11 is designed as a line modulator and comprises a plurality of pixels arranged in a row. Each pixel can be switched between an on-state and an off-state, e.g. by an electronically controllable diffraction grating, so that the respective beam is only reflected to the polarizing beam splitter 10 in the on-state and subsequently guided to the optical imaging unit 13.

The beam splitter 9 is configured to generate a plurality of beams that are distributed along the row of pixels and the deflection unit 5 is configured to displace the plurality of beams together along the row of pixels, i.e. to scan the row of pixels. Depending on whether the respective pixel is in the on-state or off-state, the beam is reflected by the light modulator and introduced into the material 2 at the corresponding position.

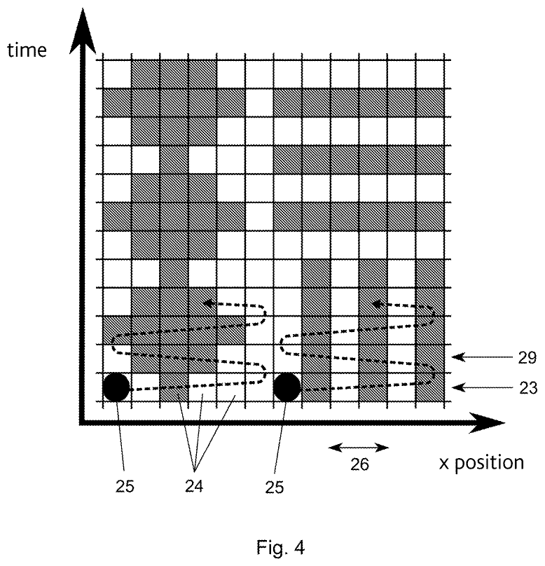

After scanning the row of pixels and generating corresponding solidified volume elements in the material 2, which are arranged, for example, in a row running in the y-direction, a change is made to the next row by arranging the carrier 1 on an X-Y table which is displaceable in the x-direction relative to the optical imaging unit 13. In this way, volume elements can be generated in a multitude of lines. This is shown schematically in FIG. 4.

FIG. 4 shows a row 23 of pixels 24 extending in the x-direction, for example. In the present example, the beam splitter generates two beams 25 which are arranged at a mutual distance of six pixels. The deflection device causes this group of 2 beams 25 to move according to the arrow 26 and in this way scan the row of pixels 23. A volume element is to be solidified at the points represented by the dark-colored pixels. This is achieved by switching these pixels to the on-state in the light modulator. After scanning the row 23, the carrier 1 is shifted by one unit in the y-direction so that further volume elements can be solidified in addition to the previously solidified volume elements, as indicated by the arrow 29. When the row of pixels is scanned, other pixels are now switched to the on-state so that the pattern shown in FIG. 4 is created after a number of lines.

In order to build up the component layer by layer, volume elements of one layer after another are solidified in the material 2. To build up a first layer, the laser beams are each focused successively on focal points arranged in the focal plane of the optical imaging unit 13 within the material 2. To change to the next plane, the optical imaging unit 13, which is attached to a carrier 15, is moved in the z-direction relative to the carrier 1 by the distance between layers. Alternatively, the carrier 1 can also be adjusted relative to the fixed optical imaging unit 13.

Further, a control unit 16 is provided, which controls the deflection unit 5, the beam splitter 9, the light modulator 11, the height adjuster 15 and the carrier 1 attached to the X-Y table.

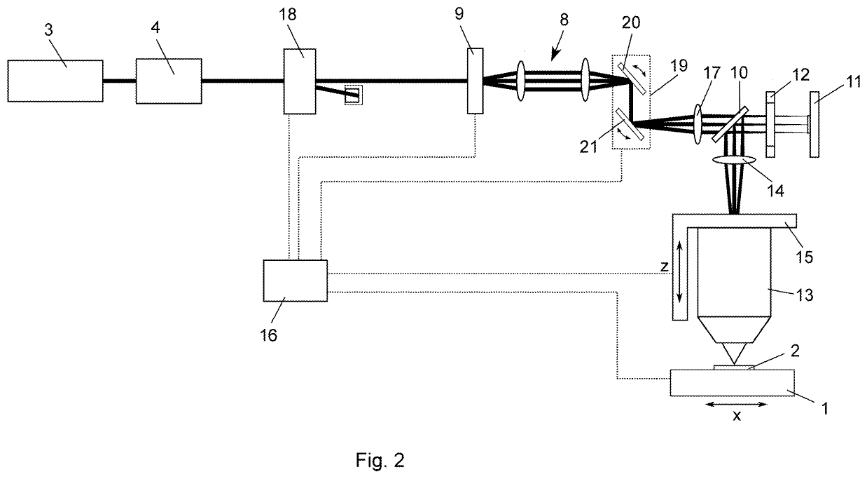

In the configuration shown in FIG. 2, the spatial light modulator 11 comprises a two-dimensional pixel grid, in contrast to the configuration shown in FIG. 1. A deflection unit 19 is therefore provided, which is capable of deflecting the plurality of beams generated by the beam splitter 9 about two vertical axes. For this purpose, the deflection unit 19 comprises a first scanner 20 and a second scanner 21, which are controlled in such a way that the first scanner scans a row of pixels (in the x-direction) as described in connection with the configuration according to FIG. 1 and the second scanner deflects the beams transversely thereto (in the y-direction) from one row to the next row. A further difference to the configuration according to FIG. 1 is that the deflection unit 19 is arranged after the beam splitter 9. Furthermore, an acousto-optical modulator 18 is arranged in front of the beam splitter 9, which serves to set the global power limit and to limit the power at the turning points of the scanner in order to prevent damage to the modulator.

Due to the use of a spatial light modulator 11 with a two-dimensional pixel array, volume elements can be generated within a two-dimensional writing area of the optical imaging unit 13. If the component to be produced is larger in the x and/or y direction than the writing area of the optical imaging unit 13, substructures of the component are built up next to each other (so-called stitching). For this purpose, the carrier 1 is arranged on an X-Y table, which can be moved in the x- and/or y-direction relative to the optical imaging unit 13.

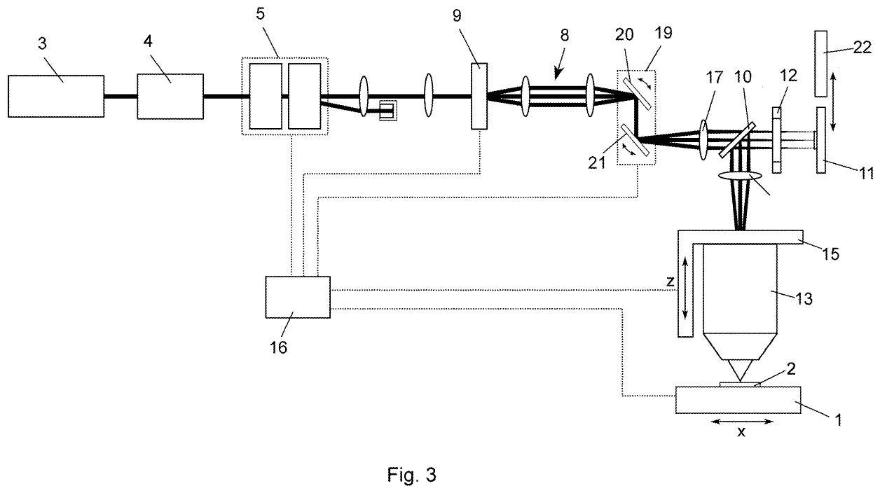

The configuration according to FIG. 3 differs from the configuration according to FIG. 2 in that a mirror 22 can be brought into the beam path instead of the spatial light modulator 11 if the functionality of the light modulator 11 can be dispensed with.

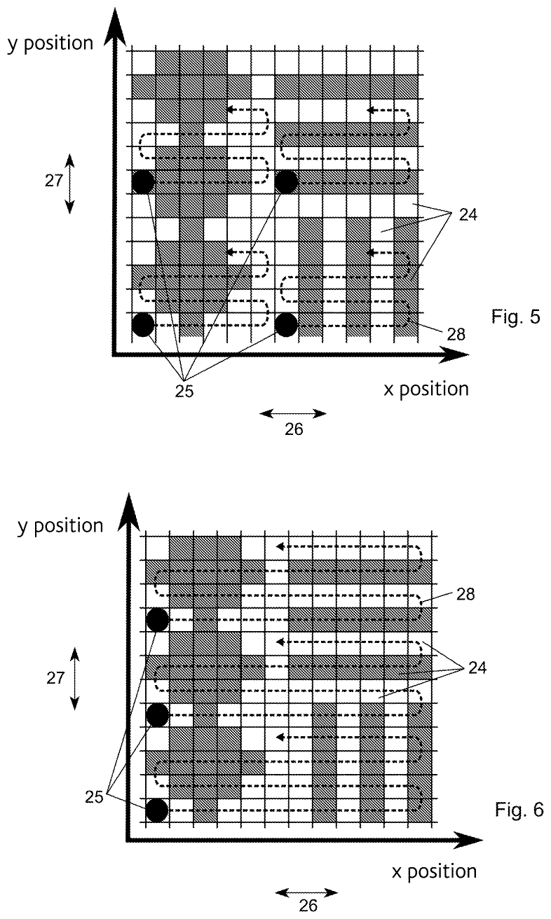

The raster scanning of the two-dimensional pixel grid of the spatial modulator is shown in FIG. 5 and FIG. 6. Here, the individual pixels are again labelled 24 and it can be seen that the pixels 24 are provided in several lines, i.e. in a two-dimensional arrangement. In the embodiment according to FIG. 5, the beam splitter generates four beams 25 in a square arrangement, whereby the individual beams are each moved two-dimensionally across the pixel grid along the path labelled 28 by means of the deflection device. The beams are deflected in the direction of the double arrow 26 (x-direction), e.g. by means of an acousto-optical deflector, and the beams are deflected in the direction of the double arrow 27 (y-direction), e.g. by means of a galvanometer scanner. By switching between the on-state and the off-state, the pattern shown in FIG. 5 is generated, whereby a volume element is solidified at the points represented by the dark-colored pixels (on-state).

In the embodiment according to FIG. 6, the beam splitter generates three beams 25 in a linear arrangement, whereby the individual beams are each moved two-dimensionally across the pixel grid along the path designated 28 by means of the deflection device. The beams are deflected in the direction of the double arrow 26 (x-direction), e.g. by means of a resonance scanner, and the beams are deflected in the direction of the double arrow 27 (y-direction), e.g. by means of a galvanometer scanner.

1-21. (canceled)

22. A method for lithography-based generative manufacturing of a three-dimensional component, comprising:
splitting, with a beam splitter, a beam emitted by an electromagnetic radiation source into a plurality of beams;
focusing, by an optical imaging unit, the plurality of beams onto focal points within a material; and
displacing the focal points by a deflection unit arranged upstream of the optical imaging unit in the beam direction;
wherein volume elements of the material located at the respective focal points are successively solidified by multiphoton absorption; and
wherein a spatial light modulator having a plurality of electronically controllable pixels is provided which are scanned by the plurality of beams and which are switched individually between at least one on-state and an off-state depending on the geometry of the component to be realized, so that the respective beam is guided to the imaging unit only in the at least one on-state.

23. The method according to claim 22, wherein:
the at least one on-state comprises at least a first on-state and a second on-state;
the pixels are individually switched between the off-state and the first on-state and the second on-state; and
the first on-state and the second on-state generate different radiation intensities at the focal point.

24. The method according to claim 22, wherein a radiation intensity of each pixel of the spatial light modulator is adjustable and the radiation intensity is adjusted depending on the exposure time of the pixels so that the volume elements receive a same radiation power.

25. The method according to claim 22, wherein a radiation intensity of each pixel of the spatial light modulator is adjustable and the radiation intensity is adjusted so that volume elements receive different radiation power from one another in order to produce volume elements with different spatial dimensions from one another.

26. The method according to claim 22, wherein the pixels of the spatial light modulator are arranged in at least one row extending along a straight line and the splitting of the beams is carried out by means of the beam splitter along the straight line, so that the beams impinge on the row of pixels spaced apart by a plurality of pixels.

27. The method according to claim 26, wherein the pixels of the spatial light modulator are arranged in a plurality of parallel rows and the plurality of beams are deflected about a first axis and a second axis.

28. The method according to claim 22, wherein the plurality of beams are directed to the spatial light modulator with the interposition of a polarizing beam splitter, the beams being reflected by the spatial light modulator and impinging with changed polarization on the polarizing beam splitter, which directs the beams to the optical imaging unit.

29. The method according to claim 22, wherein a mirror is provided and in that the spatial light modulator and the mirror are displaced in such a way that either the spatial light modulator or the mirror is brought into a working position arranged in the beam path.

30. The method according to claim 22, wherein the component is built up layer by layer with layers extending in an x-y plane, the change from one layer to a next layer comprising the change in a relative position of the optical imaging unit relative to the component in a z direction running perpendicular to the x-y plane.

31. A device for lithography-based generative manufacturing of a three-dimensional component, comprising:
a material carrier for a solidifiable material; and
an irradiation device configured to be controlled for position-selective irradiation of the solidifiable material with at least one beam;
wherein the irradiation device comprises:
a beam splitter for splitting an input beam into a plurality of beams,
a deflection unit arranged one of upstream and downstream of the beam splitter in the beam path, and
an optical imaging unit arranged downstream of the deflection unit and the beam splitter;
wherein the irradiation device is configured to focus each beam successively onto focal points within the material;
wherein a volume element of the material located at the respective focal point can be solidified by multiphoton absorption; and
wherein a spatial light modulator with a plurality of electronically controllable pixels is arranged between:
the optical imaging unit; and
the beam splitter and the deflection unit;
wherein the spatial light modulator is configured to be scanned by the plurality of beams and configured to be be switched individually between at least one on-state and an off-state, so that the respective beam is guided to the imaging unit only in the at least one on-state.

32. The device according to claim 31, wherein:
the at least one on-state comprises at least a first on-state and a second on-state;
the pixels are individually switchable between the off-state and the first on-state and the second on-state; and
the first on-state and the second on-state generate different radiation intensities at the focal point.

33. The device according to claim 31, wherein the spatial light modulator comprises a one-dimensional arrangement of the pixels.

34. The device according to claim 31, wherein the spatial light modulator comprises a dynamically adjustable diffraction grating.

35. The device according to claim 31, wherein the deflection unit comprises at least one acousto-optical modulator.

36. The device according to claim 31, wherein the spatial light modulator comprises a two-dimensional arrangement of the pixels.

37. The device according to claim 36, wherein the spatial light modulator comprises a reflective liquid crystal microdisplay.

38. The device according to claim 36, wherein the deflection unit comprises a two-axis deflection unit.

39. The device according to claim 31, wherein a polarizing beam splitter is assigned to the spatial light modulator, through which the plurality of beams is directed onto the spatial light modulator and which deflects the beams reflected by the spatial light modulator to the optical imaging unit.

40. The device according to claim 39, wherein a waveplate is arranged between the polarizing beam splitter and the spatial light modulator.

41. The device according to claim 31, wherein a mirror is provided and in that the spatial light modulator and the mirror can be displaced so that one of the spatial light modulator and the mirror is configured to be brought into a working position arranged in the beam path.

42. The device according to claim 31, wherein the irradiation device is configured to build up the component layer by layer with layers extending in an x-y plane, the change from one layer to a next layer comprising the change in a relative position of the optical imaging unit relative to the component in a z-direction perpendicular to the x-y plane.
